(19) United States
(12) Patent Application Publication
(10) Pub. No.: US 2024/0012729 A1
(43) Pub. Date: Jan. 11, 2024

(54) CONFIGURABLE MONITORING AND ACTIONING WITH DISTRIBUTED PROGRAMMABLE PATTERN RECOGNITION EDGE DEVICES

(71) Applicant: AONDEVICES, INC., Irvine, CA (US)

(72) Inventors: Mouna Elkhatib, Irvine, CA (US); Adil Benyassine, Irvine, CA (US); Aruna Vittal, Irvine, CA (US); Daniel Schoch, Irvine, CA (US); Ziad Mansour, Irvine, CA (US)

(21) Appl. No.: 18/348,917

(22) Filed: Jul. 7, 2023

Related U.S. Application Data
(60) Provisional application No. 63/359,061, filed on Jul. 7, 2022.

(51) Int. Cl. G06F 11/30

(52) U.S. Cl. CPC G06F 11/3006; G06F 11/3072

(57) ABSTRACT

A configurable monitoring and actioning system has one or more programmable edge devices each including a machine learning pattern recognizer, a sensor providing sensor input data to the pattern recognizer, and a memory storing pre-trained machine learning weight values for the pattern recognizer. Event detections are generated based upon evaluations of the sensor input data from the sensor against the pre-trained machine learning weight values. An application installable on a user device is in communication with each of the one or more programmable edge devices and executes predetermined actions based upon the event detection evaluations from the machine learning pattern recognizer.

### CROSS-REFERENCE TO RELATED APPLICATIONS

This application relates to and claims the benefit of U.S. Provisional Application No. 63/359,061 filed Jul. 7, 2022, and entitled “METHOD FOR A CONFIGURABLE MONITORING AND ACTION TAKING SYSTEM UTILIZING DISTRIBUTED PROGRAMMABLE PATTERN RECOGNITION DEVICES AT THE EDGE MANAGED BY A SOFTWARE APPLICATION,” the entire disclosure of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to human-computer interfaces and machine learning, and more particularly to configurable monitoring and actioning with distributed programmable pattern recognition edge devices managed by a client software application.

### 2. Related Art

Current home or building security systems are built upon fixed function devices that monitor a specific pattern of inputs from various environmental sensors. Such sensors may be microphones that capture sound from the monitored environment and a controller may evaluate the audio as a specific type of event. For example, glass breakage sensors may monitor for sounds that are characteristic thereof. There may also be electro-mechanical sensors such as those installed on doors, windows, and the like where electrical continuity is broken when opened and triggers an alarm condition. Optical sensors may monitor movement within the environment.

Regardless of the specific inputs or sensor types, when the pattern is detected, an alarm is enabled, or a signal is sent to an electronic device such as a phone or other mobile communication device to signal the detection. Such solutions are rigid and fixed to specific functions. Current systems are capable of providing only a fixed notification of a pre-determined event with no possibility of any follow up action. Furthermore, the user's privacy may be compromised to the extent cloud processing is needed. The ability to take effective action following the detection of an event may also be limited. As time goes on, the functionality of the sensing devices may become less useful or obsolete, and the user is pushed to acquire new ones for newly needed functions. For example, a baby crying detection device may become unnecessary as the child ages.

Accordingly, there is a need in the art for the configurable monitoring and actioning using distributed programmable pattern recognition edge devices managed by a client software application on user devices.

### BRIEF SUMMARY

The embodiments of the present disclosure are directed to various methods and systems for a configurable monitoring and actioning system utilizing distributed programmable pattern recognition edge devices managed by a software application. The features of the method and system contemplates the pattern recognition being configurable by the user for time-of-day, environmental conditions, situation of the house, family needs and so on, and provide the user with the ability to take definitive follow up action to resolve the triggering event. Additionally, there are various privacy advantages, in that each edge device performs pattern recognition locally without sharing the audio or the image with an application. Once a pattern is recognized, an interrupt and a notification is sent to the application, which can then take a predetermined action. The application may contain a dashboard of all edge devices and reported detection history, but once an edge device is reprogrammed to a different pattern recognition, the history may be deleted with the start of a new log.

According to one embodiment of the present disclosure, there may be a configurable monitoring and actioning system. It may include one or more programmable edge devices each including a machine learning pattern recognizer, a sensor providing sensor input data to the pattern recognizer, and a memory storing pre-trained machine learning weight values for the pattern recognizer. The machine learning pattern recognizer may generate event detections based upon evaluations of the sensor input data from the sensor against the pre-trained machine learning weight values. The system may also include an application installable on a user device. The application may be in communication with each of the one or more programmable edge devices and execute predetermined actions based upon the event detection evaluations from the machine learning pattern recognizer.

Another embodiment of the present disclosure is directed to a method of monitoring and operating one or more programmable edge devices from a user device. The method may include establishing a communication link to the one or more programmable edge devices. There may also be a step of receiving event detections from one or more programmable edge devices. The event detections may be generated by a machine learning pattern recognizer on an originating one of the one or more programmable edge devices based on sensor input data captured thereby and evaluated against pre-trained machine learning weight values stored thereon. There may also be a step of correlating the event detections to one or more actions, as well as a step of executing the one or more actions on the user device.

An embodiment of the disclosure may also be a non-transitory computer readable medium that includes instructions executable by a data processing device to perform the method of monitoring and operating one or more programmable edge devices from a user device. The present disclosure will be best understood accompanied by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a set of edge devices that may be used in a configurable monitoring and actioning system;

FIG. 2 is a block diagram of one exemplary edge device with which various embodiments of the configurable monitoring and actioning system may be implemented;

FIG. 3 is a block diagram showing the components of one embodiment of the configurable monitoring and actioning system;

FIG. 4 is a diagram showing the library of detection patterns that may be selectable in the configurable monitoring and actioning system;

FIG. 5 is a block diagram of an example configuration scheduler;

FIG. 6 is a flowchart showing the steps of basic monitoring and actioning according to an embodiment of the present disclosure;

FIG. 7 is a flowchart showing the steps of programmable monitoring and actioning according to an embodiment of the present disclosure; and

FIG. 8 is a flowchart showing the steps of interactive monitoring and actioning according to an embodiment of the present disclosure.

### DETAILED DESCRIPTION

The detailed description set forth below in connection with the appended drawings is intended as a description of the several presently contemplated embodiments of a configurable monitoring and actioning system. It is not intended to represent the only form in which such embodiments may be developed or utilized, and the description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

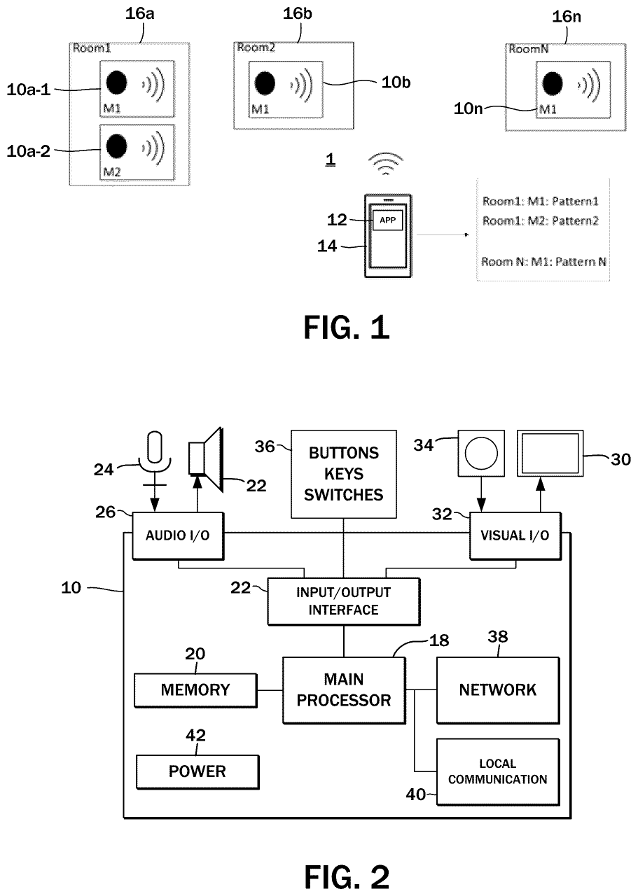

With reference to the block diagram of FIG. 1, one embodiment of a configurable monitoring and actioning system 1 includes one or more programmable edge devices 10 and an application 12 installable on a user device 14. In the illustrated application, the configurable monitoring and actioning system 1 is being utilized as a physical space alerting system that may serve security and occupant health/safety purposes, among others. In this regard, the edge devices 10 may be deployed to a variety of subunits of an environment 16, e.g., a home, commercial building, hospital, etc. including a first room 16a, a second room 16b, and an arbitrary room 16n. In the first room 16a, there may be a primary first room edge device 10a-1 and a secondary first room edge device 10a-2. In the second room 16b, there may be a second room edge device 10b, and in the arbitrary room 16n, there may be an arbitrary room edge device 10n. Additional deployment environments also include automobiles, outdoor locations, and so on, and the embodiments of the present disclosure are not limited to a specific installation.

Referring to FIG. 2, the edge device 10 may be a smart speaker, a smart television set, a headset, a television remote controller, a refrigerator, a smart watch, or any other device that is capable of receiving an input and initiating further action on the device on which the input was received or any other device linked thereto. It is understood that conventional household appliances such as washing machines, dryers, dishwashers, ovens, garage door openers and the like may incorporate additional data processing capabilities and may thus be referred to as edge devices as well. These data processing capabilities may be utilized to implement a virtual assistant with which users may interact via voice commands, though it is also possible to interact via other inputs such as gestures and other image-based modalities. Within the audio context, the edge device 10 may respond to other types of audio besides user voice commands as will be elaborated upon below.

The edge device 10 includes a main processor 18 that executes pre-programmed software instructions that correspond to various functional features of the edge device 10. These software instructions, as well as other data that may be referenced or otherwise utilized during the execution of such software instructions, may be stored in a memory 20. As referenced herein, the memory 20 is understood to encompass random access memory as well as more permanent forms of memory.

To the extent that the edge device 10 is a smart speaker, it is understood to incorporate a loudspeaker/audio output transducer 22 that outputs sound from corresponding electrical signals applied thereto. Furthermore, in order to accept audio input, the edge device 10 includes a microphone/audio input transducer 24. The microphone 24 is understood to capture sound waves and transduces the same to an electrical signal. According to various embodiments of the present disclosure, the edge device 10 may have a single microphone. However, it will be recognized by those having ordinary skill in the art that there may be alternative configurations in which the edge device 10 includes two or more microphones.

Both the loudspeaker 22 and the microphone 24 may be connected to an audio interface 26, which is understood to include at least an analog-to-digital converter (ADC) and a digital-to-analog converter (DAC). The ADC is used to convert the electrical signal transduced from the input audio waves to discrete-time sampling values corresponding to instantaneous voltages of the electrical signal. This digital data stream may be processed by the main processor, or a dedicated digital audio processor. The DAC, on the other hand, converts the digital stream corresponding to the output audio to an analog electrical signal, which in turn is applied to the loudspeaker 22 to be transduced to sound waves. There may be additional amplifiers and other electrical circuits within the audio interface 26, but for the sake of brevity, the details thereof are omitted. Furthermore, although the example edge device 10 shows a unitary audio interface 26, the grouping of the ADC and the DAC and other electrical circuits is by way of example and convenience only, and not of limitation.

In between the audio interface 26 and the main processor 18, there may be a general input/output interface 28 that manages the lower-level functionality audio interface 26 without burdening the main processor 18 with such details. Although there may be some variations in the way the audio data streams to and from the audio interface 26 are handled thereby, the general input/output interface 28 abstracts any such variations. Depending on the implementation of the main processor 18, there may or may not be an intermediary input/output interface 28.

According to some embodiments, the edge device 10 may also incorporate visual input and output peripheral components. Specifically, there may be a display 30 that outputs graphics corresponding to electrical signals the data representative thereof. The display 30 may be a matrix of light emitting elements arranged in rows and columns, with the elements thereof varying in size and technologies, such as liquid crystal displays (LCD), light-emitting diode (LED) displays and so on. It will also be appreciated that the display 30 may include simpler output devices such as segment displays as well as individual LED indicators and the like. The specific type of display that is incorporated into the edge device 10 is driven by the information presentation needs thereof.

The display 30 receives the electrical signals to activate the display elements from a visual interface 32. In some implementations, the visual interface 32 is a graphics card that has a separate graphics processor and memory to offload the graphics processing tasks from the main processor 18. Like the audio interface 26 discussed above, the visual interface 32 may be connected to the general input/output interface 28 to abstract out the functional details of operating the display and the visual interface 32.

The edge device 10 may further include an imager 34 that captures light from the environment and converts the same to electrical signals representative of the scene. A continuous stream or sequence of images may be captured by the imager 34, or a single image may be captured of a time instant in response to the triggering of a shutter. A variety of sensor technologies are known in the art, as are lenses, apertures, shutters, and other optical components that focus the light onto the sensor element for capture. Accordingly, such details of the imager 34 are omitted. The image data output by the imager 34 may be passed to the visual interface 32, and the commands to activate the capture function may be issued through the same. However, this is by way of example only, and some edge devices 10 may utilize a dedicated imager interface separate from that which controls the display 30. The imager 34 and the display 30 are shown connected to a unitary visual interface 32 only for the sake of convenience as representing functional corollaries of the other (e.g., image input vs. image output).

In addition to the foregoing peripheral devices, the edge device 10 may also include more basic input devices 36 such as buttons, keys, and switches with which the user may interact to command the edge device 10. These components may be connected directly to the general input/output interface 28.

The edge device 10 may also include a network interface 38, which serves as a connection point to a data communications network. This data communications network may be a local area network, the Internet, or any other network that enables a communications link between the edge device 10 and a remote note. In this regard, the network interface 38 is understood to encompass the physical, data link, and other network interconnect layers.

In order to communicate with more proximal devices within the same general physical space as the edge device 10, there may be a local communication interface 40. According to various embodiments, the local communication interface 40 may be a wireless modality such as infrared, Bluetooth, Bluetooth Low Energy, RFID, and so on. Alternatively, or additionally, the local communication interface 40 may be a wired modality such as Universal Serial Bus (USB) connections, including different standard generations and physical interconnects thereof (e.g., USB-A, micro-USB, mini-USB, USB-C, etc.). The local communication interface 40 is likewise understood to encompass the physical, data link, and other network interconnect layers, but the details thereof are known in the art and therefore omitted from the present disclosure. In various embodiments, a Bluetooth connection may be established between a smartphone and the edge device 10 to implement certain features of the present disclosure.

As the edge device 10 is electronic, electrical power must be provided thereto in order to enable the entire range of its functionality. In this regard, the edge device 10 includes a power module 42, which is understood to encompass the physical interfaces to line power, an onboard battery, charging circuits for the battery, AC/DC converters, regulator circuits, and the like. Those having ordinary skill in the art will recognize that implementations of the power module 42 may span a wide range of configurations, and the details thereof will be omitted for the sake of brevity.

The main processor 18 is understood to control, receive inputs from, and/or generate outputs to the various peripheral devices as described above. The grouping and segregation of the peripheral interfaces to the main processor 18 are presented by way of example only, as one or more of these components may be integrated into a unitary integrated circuit. Furthermore, there may be other dedicated data processing elements that are optimized for machine learning/artificial intelligence applications. One such integrated circuit is the AONDevices high-performance, ultra-low power edge AI device, AON1100 pattern recognition chip/integrated circuit. However, it will be appreciated by those having ordinary skill in the art that the embodiments of the present disclosure may be implemented with any other data processing device or integrated circuit utilized in the edge device 10. Although a basic enumeration of peripheral devices such as the loudspeaker 22, the microphone 24, the display 30, the imager 34, and the input devices 36 has been presented above, the edge device 10 need not be limited thereto. In some cases, one or more of these exemplary peripheral devices may not be present, while in other cases, there may be other, additional peripheral devices.

Returning to FIG. 1, the user device 14 is understood to be a smartphone, tablet, laptop computer, desktop computer, or other device that includes various wireless communication modalities. These include cellular modalities, as well as local area networking modalities such as WiFi and Bluetooth. With these wireless networking modalities, the user device 14 may communicate with the edge devices 10. The user device 14 may implement a wide range of functionality through different software applications, which are colloquially known as “apps” in the mobile device context. The software application(s) are comprised of pre-programmed instructions that are executed by a central processor and that may be stored on an onboard memory. The results of these executed instructions may be output for viewing by a user, and the sequence/parameters of those instructions may be modified via inputs from the user. Among such software applications installed on the user device 14 include the aforementioned application 12.

In a conventional smartphone device, the user primarily interacts with a graphical user interface that is generated on the display and includes various user interface elements that can be activated based on haptic inputs received on the touch screen at positions corresponding to the underlying displayed interface element. Those having ordinary skill in the art will recognize other possible input/output devices that could be integrated into the user device 14, and the purposes such devices would serve. Other smartphone devices may include keyboards (not shown) and other mechanical input devices, and the presently disclosed interaction methods detailed more fully below are understood to be applicable to such alternative input modalities.

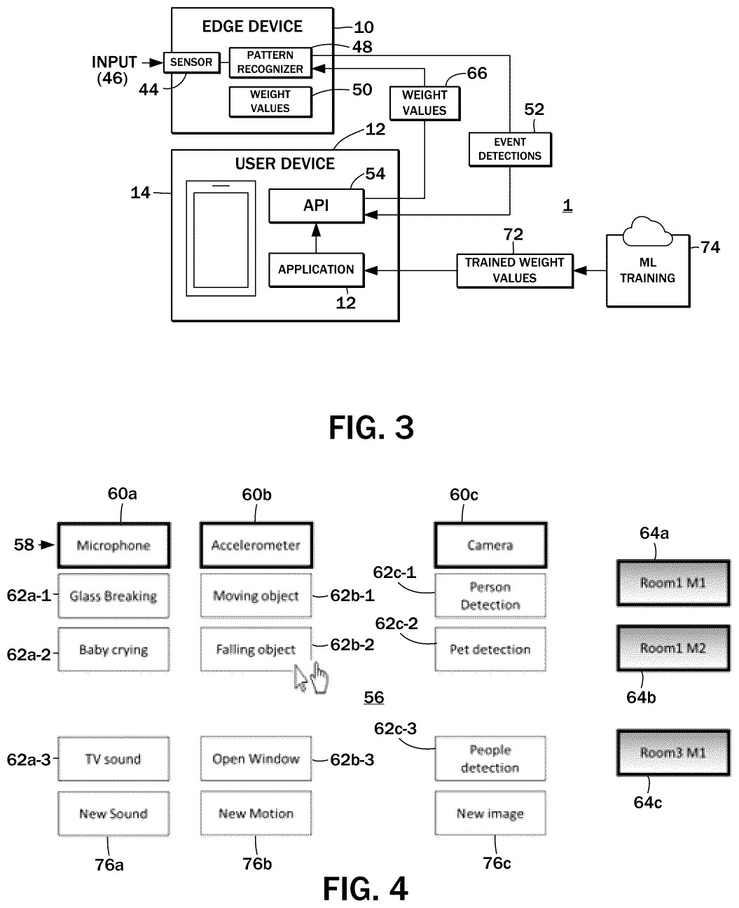

With reference to FIG. 3, the edge device 10 is configured to accept environmental inputs 46 via sensors 44, such as the aforementioned microphone 24, the imager 34, or any other like device that can quantify a condition, state, or status pertaining to the environment it is sensing, such as temperature, humidity, fluid level, accelerometer, heart rate, blood oxygen level, and so on. The edge device 10 is further configured to process such inputs 46 and derive some meaning or understanding therefrom based upon a machine learning/pattern recognition function. To this end, the main processor 18 implements a machine learning pattern recognizer 48 that is programmed to function with pre-trained weight values 50 that are stored in the memory 20. The main processor 18 may thus be referred to as a pattern recognition integrated circuit. The specific machine learning modality that is implemented may be varied, including multilayer perceptrons, convolutional neural networks (CNNs), recurrent neural networks (RNNs) and so on that utilize such pre-trained weights to perform pattern recognition functions associated therewith.

Based upon the pre-trained weight values 50, the machine learning pattern recognizer 48 evaluates the inputs 46 to generate an event detection 52 if the input 46 corresponds thereto. The event detection 52 is provided to the user device 14, and specifically an application programming interface (API) 54 to the edge device 10 installed thereon. The application 12 may utilize the API 54 to retrieve the event detection and generate an alert on the user device 14 representative of the event detection 52. By way of example, the edge device 10 may be programmed to alert on breaking glass. If the audio data captured by the microphone 24/sensor 44 is evaluated to be broken glass by the machine learning pattern recognizer 48 based upon the pre-trained weight values 50 for breaking glass sound, then the event detection indicating broken glass as detected by the edge device 10 is transmitted to the API 54. The application 12 may, in turn, generate an alert that the sound of breaking glass was detected in the space being monitored by the edge device 10.

In order to improve upon the pattern recognition function, a small excerpt of the captured input 46 may be transmitted to the application 12 for targeted performance enhancement.

The configurable monitoring and actioning system 1 extends this functionality of a single edge device 10 to multiple instances, and each one may be configured to detect different events such as baby crying sounds, television sounds, presence of a human being, coughing sounds, movement of furniture, and so on. Referring back to FIG. 1, the primary edge device 10a-1 in the first room 16a may be configured to detect a first pattern, while the secondary first room edge device 10a-2 in the same room may be configured to detect a second pattern. The edge device in the second room 16b may be configured to detect the first pattern.

The assignment of different patterns to specific rooms 16 may be possible through a user interface of the application 12. FIG. 4 depicts one possible implementation of such a user interface 56 where the user may select a pattern recognition event from a library. In a first row 58, there may be a series of icons 60 representative of the sensors 44. As discussed above, a given sensor 44 may be programmed to detect different events, and underneath the respective icons of the first row 58, there may be a movable icons 62 corresponding to each event detectable by the associated sensor 44. Under the first icon 60a for the microphone, there may be a first icon 62a-1 for a glass breaking event, a second icon 62a-2 for a baby crying event, and a third icon 62a-3 for a television sound. Under the second icon 60b for the accelerometer, there may be a first icon 62b-1 for a moving object event, a second icon 62b-2 for a falling object event, and a third icon 62b-3 for a falling object event. Under the third icon 60c for the camera, there may be a first icon 62c-1 for a person detection event, a second icon 62c-3 for a pet detection event, and a third icon 62c-3 for a people detection event. To the right of the sensor/event portion, there is a room and edge device assignment portion including a first icon 64a for the primary edge device in the first room 16a, and a second icon 64b for the secondary edge device in the first room 16a. There is also a third icon 64c for the one edge device in the second room 16b. When an event is to be assigned to a specific room/edge device 10, the corresponding icon 62 may be selected and dragged to the room/edge device icon 64.

With the assignment of a different pattern to the edge device 10 via the user interface 56, the corresponding pre-trained weight value 66 may be transmitted to the designated edge device 10, where it is stored as the pre-trained weight value 50 in the memory 20. Henceforth, the machine learning pattern recognizer 48 generates the event detection 52 when the input 46 is evaluated to be the selected event. The updates to the pre-trained weight values 50 may be performed wirelessly over the air.

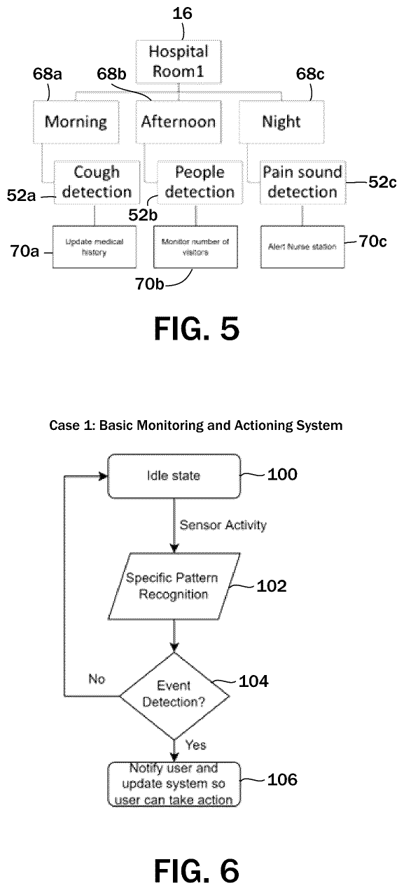

The application 12 is understood to include a scheduler that reprograms the system 1 based upon various secondary conditions such as time of day, environmental conditions, situation of the building/home/facility, as well as personal needs. The block diagram of FIG. 5 illustrates an implementation of a scheduler for one room 16 segregated into time-of-day 68 of morning 68a, afternoon 68b, and night 68c. The specific edge device 10 is assigned to perform different event detections 52 depending on the time of day, including a cough detection event 52a in the morning 68a, people detection event 52b in the afternoon 68b, and a pain sound detection event 52c at night 68c. As each time window is reached, the application 12 may upload the corresponding pre-trained weight value 66 to the edge device 10. The action to take upon the event detection 52 may be configured in the scheduler. For example, when the cough detection event 52a is received, the application 12 may take an action 70a of updating a patient's medical history. When the people detection event 52b is received, the application 12 may taken an action 70b of monitoring the number of visitors to the room 16. When the pain sound detection event 52c is received, the application 12 may taken an action 70c of alerting a nurse station. Those having ordinary skill in the art will recognize the numerous possibilities for configuring a scheduler depending upon the specific application and deployment environment of the system 1, and so the scope of the present disclosure is not intended to be limited to the foregoing example.

In addition to the existing pattern selected from the local library on the user device 14, further patterns and associated weight patterns may retrieved from a remote source. Updated pre-trained weight values 72 may be retrieved by the application 12 via the API 54 from a machine learning training source 74 such as a vendor of the edge device 10. Referring again to FIG. 4, the user interface 56 may include icons 76 for adding more pre-trained weight values 72 for specific sensors 44. For instance, a new sound icon 76a grouped under the microphone icon 60a may be selected to add a new pre-trained weight value 72 that is used by the machine learning pattern recognizer 48 for evaluating sound data. A new motion icon 76b grouped under the accelerometer icon 60b may be selected to add a new pre-trained weight value 72 used by the machine learning pattern recognizer 48 to evaluate motion data. A new image icon 76c grouped under the camera icon 60c may be selected to add a new pre-trained weight value 72 for evaluating image data. The additional pre-trained weight value 72 may be uploaded to the edge device 10 in the manner discussed above.

The flowchart of FIG. 6 describes the operational flow of a basic monitoring and actioning system accordance with one embodiment of the present disclosure. In a step 100, the system 1 is in an idle state until activity by the designated sensor 44 is detected. In a step 102, the edge device 10, by way of the machine learning pattern recognizer 48, performs its evaluation of the input 46 based upon the pre-trained weight values 50 using the aforementioned deep learning algorithm that may be based on multilayer perceptron (MLP), Convolutional Neural Network (CNN) or a recurrent neural network (RNN). If, in an evaluation block 104 the sensor activity is determined to not be the pre-programmed pattern to be recognized, there is no event detected and the system 1 returns to the idle state 100. If, however, the sensor activity is determined to be the pre-programmed pattern to be recognized, the event detection 52 is transmitted to the application 12 hosted on the user device 14 in accordance with a step 106. The application 12 then takes further action. An example of the basic monitoring and actioning system is if the user has selected water leakage monitoring for certain section of the house from the library of pattern recognitions, upon detection of a water leak in specified node, the system 1 notifies the application 12, after which the application 12 switches to a pre-determined voice command weights and the user will be able to shut the water to the specified node using a voice command.

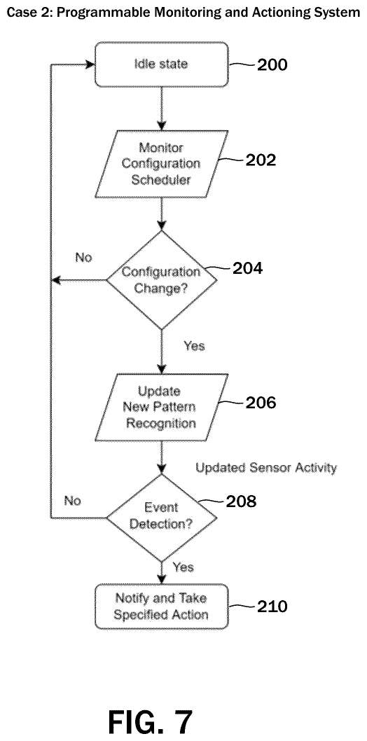

The flowchart of FIG. 7 describes the operational flow of a programmable monitoring and actioning system in accordance with another embodiment of the present disclosure. In a step 200, the system 1 is in an idle state until the monitor configuration scheduler notifies the application 12 of a potential configuration change for the specific edge device 10/machine learning pattern recognizer 48 in a step 202. If there is a configuration change as determined in a decision block 204, the application 12 updates the device pattern recognition functionality with new weights from memory per step 206. Next, updated sensor activity is detected by the edge device 10, and performs the pattern recognition functionality associated with the updated programmed weights. If the sensor activity is not the updated specified pre-programed pattern recognized by the edge device 10 as determined in a decision block 208, there is no event detection by the device and system goes back to idle state 200. However, if sensor activity is identified as pre-programed pattern by the edge device 10, a notification is sent to the application 12 hosted on the user device 14 according to a step 210. The application 12 will then take further specified action. An example of the programmable monitoring and actioning system may be the aforementioned hospital setting and description of the operation of the scheduler.

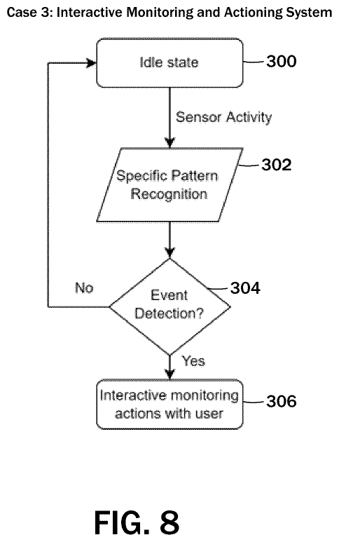

The flowchart of FIG. 8 describes the operational flow of an interactive monitoring and actioning system in accordance with another embodiment of the present disclosure. In a step 300, the system 1 is in an idle state until activity by the designated sensor 44 is detected. In a step 302, the edge device 10, by way of the machine learning pattern recognizer 48, performs its evaluation of the input 46 based upon the pre-trained weight values 50 using the aforementioned deep learning algorithm. If the sensor activity is not the specified pre-programed pattern recognized by the edge device 10 according to an evaluation block 304, there is no event detection and the system 1 returns to the idle state 300. However, if the sensor activity is identified as the pre-programed pattern by the edge device, a notification is sent to the application 12 hosted on the user device 14. The application 12 will then take interactive monitoring actions with the user per step 306.

An example of this embodiment of the interactive monitoring and actioning system 1 is where the user has selected dog barking or whimpering monitoring for a certain section of the user's house from the library of pattern recognition. Upon detecting a dog barking or whimpering in the designated section of the house, the system 1 notifies the application 12, and the application 12 will then proceed with a sequence of pre-determined checks of a scenario for dog barking or whimpering. These pre-determined checks may include first checking the temperature and if the temperature is above or below set thresholds, the user may be alerted of this reading. The edge device 10 may then be switched to pre-determined voice command weights so that the temperature can be adjusted by voice command. If the temperature is within set limits, the system 1 may switch to doorbell ringing weights. If a doorbell event is detected and a notification is sent to the application 12, a notification to the user of the event may be generated and switched to image sensing weight values. The application 12 may then send the captured image to the user and switch to pre-determined voice command weights so that the user can instruct the person ringing the doorbell.

The particulars shown herein are by way of example and for purposes of illustrative discussion of the embodiments of a configurable monitoring and actioning system and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A configurable monitoring and actioning system, comprising:
one or more programmable edge devices each including a machine learning pattern recognizer, a sensor providing sensor input data to the pattern recognizer, and a memory storing pre-trained machine learning weight values for the pattern recognizer, the machine learning pattern recognizer generating event detections based upon evaluations of the sensor input data from the sensor against the pre-trained machine learning weight values; and
an application installable on a user device, the application being in communication with each of the one or more programmable edge devices and executing predetermined actions based upon the event detection evaluations from the machine learning pattern recognizer.

2. The system of claim 1, wherein the machine learning pattern recognizer is selected from a group consisting of: a multilayer perceptron (MLP), Convolutional Neural Network (CNN), and a recurrent neural network (RNN).

3. The system of claim 1, wherein additional pre-trained machine learning weight values are transmissible from the application on the user device to any one of the one or more programmable edge devices for storage in the respective memories.

4. The system of claim 1 wherein the application includes a scheduler initiating a reprogramming of at least one of the programmable edge devices based upon a secondary condition.

5. The system of claim 4, wherein the secondary condition is selected from a group consisting of: time-of-day, environmental condition, locale condition, and user preference.

6. The system of claim 1, wherein the application includes a library of user-selectable pattern recognition events each having an associated pre-trained machine learning weight value.

7. The system of claim 1, wherein the one or more programmable edge devices are organized in a hierarchical relationship over a plurality of locations, the application maintaining the hierarchical relationship in a user interface thereto for managing the one or more programmable edge devices.

8. The system of claim 1, wherein each of the one or more programmable edge devices includes a wireless communications module, the user device and the application being in communication with the one or more programmable edge devices over a wireless link established thereby.

9. A method of monitoring and operating one or more programmable edge devices from a user device, the method comprising:
establishing a communication link to the one or more programmable edge devices;
receiving event detections from one or more programmable edge devices, the event detections being generated by a machine learning pattern recognizer on an originating one of the one or more programmable edge devices based on sensor input data captured thereby and evaluated against pre-trained machine learning weight values stored thereon;
correlating the event detections to one or more actions; and
executing the one or more actions on the user device.

10. The method of claim 9, further comprising:
reprogramming a given one of the one or more programmable edge devices for a different event detection in response to a change in a secondary condition.

11. The method of claim 10, wherein the secondary condition is selected from a group consisting of: time-of-day, environmental condition, locale condition, and user preference.

12. The method of claim 10, wherein reprogramming the given one of the one or more programmable edge devices includes transmitting a pre-trained machine learning weight value corresponding to the different event detection.

13. The method of claim 9, further comprising:
receiving an excerpt of sensor input data in conjunction with the event detection therefor; and
feeding the excerpt of the sensor input data and the corresponding event detection to a machine learning training validator.

14. The method of claim 9, further comprising:
receiving a selection of a pattern recognition event from a library of user-selectable pattern recognition events, each pattern recognition event having an associated pre-trained machine learning weight value; and
transmitting the pre-training machine learning weight value corresponding to the selected one of the pattern recognition events to the one or more programmable edge devices.

15. The method of claim 9, wherein the one or more programmable edge devices are organized in a hierarchical relationship over a plurality of locations, the application maintaining the hierarchical relationship in a user interface thereto for receiving the selection of a pattern recognition even for a specific one of the one or more programmable edge devices.

16. The method of claim 9, further comprising:
retrieving a new pattern recognition event with an associated pre-trained machine learning weight value from a remote source.

17. The method of claim 8, wherein the communication link is wireless.

18. An article of manufacture comprising a non-transitory program storage medium readable by a computing device, the medium tangibly embodying one or more programs of instructions executable by the computing device to perform a method of monitoring and operating one or more programmable edge devices from a user device, the method comprising:
establishing a communication link to the one or more programmable edge devices;
receiving event detections from one or more programmable edge devices, the event detections being generated by a machine learning pattern recognizer on an originating one of the one or more programmable edge devices based on sensor input data captured thereby and evaluated against pre-trained machine learning weight values stored thereon;
correlating the event detections to one or more actions; and
executing the one or more actions on the user device.

19. The article of manufacture of claim 18, wherein the method includes reprogramming a given one of the one or more programmable edge devices for a different event detection in response to a change in a secondary condition.

20. The article of manufacture of claim 19, wherein reprogramming the given one of the one or more programmable edge devices includes transmitting a pre-trained machine learning weight value corresponding to the different event detection.
